(19) United States
(12) Patent Application Publication
(10) Pub. No.: US 2021/0246036 A1
(43) Pub. Date: Aug. 12, 2021

(54) METHOD FOR PRODUCING ELEMENTAL SILICON

(71) Applicant: SOLAR SILICON GMBH, Nestelbach (AT)

(72) Inventor: Martin HANDL, Nestelbach (AT)

(21) Appl. No.: 16/973,906

(22) PCT Filed: Jun. 13, 2019
(86) PCT No.: PCT/EP2019/065460

§ 371 Date: Dec. 10, 2020

(30) Foreign Application Priority Data
Jun. 15, 2018 (EP) 18178006.5

(51) Int. Cl. C01B 33/025; C01B 33/037

(52) U.S. Cl. CPC C01B 33/025; C01B 33/037

(57) ABSTRACT

The invention relates to a method for the production of high-purity elementary silicon from a starting material containing silicon dioxide, which includes the steps of:
a) thermal pre-purification of the starting material, wherein impurities from the group consisting of boron and phosphorus are separated essentially completely and a pre-purified silicon dioxide is obtained;
b) reduction of the pre-purified silicon dioxide to elementary silicon; and
c) removal of impurities remaining in the pre-purified silicon dioxide after step a) during and/or after step b).

The present invention relates to a method for the production of elementary silicon from a starting material containing silicon dioxide.

Silicon is one of the most abundant elements on earth. Elementary silicon is usable for different applications. For applications in solar technology, a purity of 99.999% (5N) is required, for use in electronic products such as chips for computers, mobile phones etc., a purity of even 99.9999999% (9N) is required. In the following, silicon of a purity of at least 99.999% (5N), in particular of at least 99.9999999 (9N), is referred to as a “high-purity” silicon.

In the conventional production route of elementary, in particular high-purity silicon, a silicon-containing raw material (containing, in particular, silicon dioxide, e.g., sand) is reduced to crude silicon by means of carbon in an electric arc furnace. The obtained crude silicon is reacted with hydrochloric acid to produce trichlorosilane (HSiCl₃). Said compound is freed from impurities by distillation and finally is separated with the aid of hydrogen.

This method has adverse effects on the environment especially due to the use of chlorous chemicals.

WO 2009/06544 describes a production of silicon, wherein quartz is reduced to silicon monoxide (SiO) by means of silicon in a first step. In a second step, the obtained SiO is reduced to elementary silicon by means of carbon in a plasma furnace and is processed.

Likewise, M. B. Bibikov et al., High Energy Chemistry, 2010 (44) 1, 58-62, deal with the reduction of silicon monoxide in a plasma arc.

Jung, C. et al., J Nanosci Nanotechnol. 2013, 13 (2), 1153-8, deal with the formation of SiO from a mixture of silicon dioxide and silicon in a plasma arc.

Further ways of forming SiO are described in Hass, G., J. Am. Ceram. Soc. 12, 33, 1950 (12), 353-360.

WO 2007/102745 describes the reduction of quartz sand to elementary silicon in a plasma furnace with reducing agents such as methane, hydrogen or natural gas. A similar principle is suggested in http://laure-plasma.de/anwendungen/silizium-herstellung as well as in https://www.dbu.de/OPAC/ab/DBU-Abschlussbericht-AZ-23845.pdf, both retrieved on Jan. 25, 2017. In U.S. Pat. No. 4,680,096, a solid reducing agent is used.

Under http://www.hpqsilicon.com/silicon/, retrieved on Jun. 12, 2018, a method is presented in which quartz of a purity of 99% and more is reduced to elementary silicon in a plasma arc under vacuum by means of carbon.

RU 2 367 600 C1 describes a production of elementary silicon, wherein, in a first reaction step, silicon dioxide is reduced to silicon monoxide at temperatures of above 2500° C. directly in a plasma arc. Such a process is extremely complex and unsuitable on an industrial scale.

Li, X. et al., Metallurgical and Materials Transactions B: Process Metallurgy and Materials Processing Science, 46(5), 2384-2393 (retrieved under http://ro.uow.edu.au/eispapers/4230/on Jan. 25, 2017) describe the carbothermal reduction of quartz in a mixture of methane, hydrogen and argon.

Gardner R., Journal of Solid State Chemistry 9 (1974), 336-344, deals with the kinetics of the breakdown of silicon dioxide by means of hydrogen.

EP 2 231 518 describes the purification of elementary silicon by means of a plasma torch.

Furthermore, it is known to purify raw materials containing silicon dioxide for the production of high-purity silicon dioxide.

Methods using halogen-containing compounds are also known in this context. Furthermore, methods of thermal pre-purification are known.

Thereby, the raw material is heated to temperatures at which either

a) silicon dioxide remains essentially solid, but the impurities melt or form melt agglomerates, or
b) silicon dioxide is liquid, but the impurities evaporate.

Appropriate methods are known, for example, from EP 737 653 A1, EP 1 006 87 B1 or US 2011/0281227 A1, EP 1 910 264, U.S. Pat. No. 8,883,110, GB 1 492 920 A, EP 1 968 907, EP 1 281 679 and, respectively, EP 2 258 670. In some of those methods, halogen-containing compounds are additionally used.

The known methods for the production of elementary silicon are still very complex.

It is the object of the present invention to provide an environmentally friendly and economical method for the production of elementary silicon. In particular, the production of high-purity silicon should also be possible by means of the environmentally friendly method.

Said object is solved by a method according to claim 1.

Preferred embodiments of the method according to the invention are indicated in the subclaims.

### BRIEF DESCRIPTION OF THE FIGURES

FIG. 1 schematically shows the separation of impurities from a starting material containing silicon dioxide in a first preferred embodiment of the method according to the invention.

FIG. 2 schematically shows the separation of impurities from a starting material containing silicon dioxide in a second preferred embodiment of the method according to the invention.

FIG. 3 schematically shows the separation of impurities from a starting material containing silicon dioxide in a third preferred embodiment of the method according to the invention.

### DETAILED DESCRIPTION OF THE INVENTION

The present invention provides a smart and environmentally friendly method of obtaining elementary silicon.

The present invention is based on a combination of a thermal pre-purification of silicon dioxide, with volatile impurities being removed, i.e., impurities with a boiling point that is lower than that of silicon dioxide (step a)), and a reduction of the pre-purified silicon dioxide to elementary silicon (step b)). Impurities which remain in the silicon dioxide after the thermal pre-purification and which thus are substantially less volatile are separated in the course of the reduction to elementary silicon and/or thereafter (step c)).

An economically and ecologically favourable method of obtaining elementary silicon is thereby presented, which can be carried out in a preferred embodiment entirely without the use of halogen-containing compounds.

The thermal pre-purification is preferably carried out under atmospheric pressure in order to keep the costs for performing the method according to the invention as low as possible. However, it is also possible to perform the thermal pre-purification under vacuum or at excess pressure in order to facilitate or impede the separation of impurities with varying degrees of volatility.

The impurities separated during the thermal pre-purification in step a) are those which are more volatile than silicon dioxide. Such impurities are, for example, selected from the group consisting of boron, phosphorus, arsenic, antimony, germanium, tin, lithium or mixtures thereof.

Such impurities are generally present in the form of oxides. However, the impurities can also be present in other forms. Furthermore, it should also be noted that the impurities can be present in different types of oxides.

According to the invention at least impurities from the group consisting of boron and phosphorus are separated essentially completely in step a). Exactly these impurities cause problems during further steps of production of elementary silicon and are hard to remove after the reduction of silicon dioxide to elementary silicon, respectively.

In a preferred embodiment of the present invention further, particularly preferred all impurities with a boiling point that is lower than that of silicon dioxide are separated essentially completely in step a).

However, in case such impurities, in contrast to boron and phosphorus, can be removed by final purification steps, as e.g. by a zone melting, from the elementary silicon, an essentially complete separation thereof in step a) is not compulsory.

The term “essentially completely separated” comprises herein and in the following a content of the respective impurity after the thermal pre-purification of 10 ppm or less, preferably 1 ppm or less, more preferably 0.3 ppm or less.

In particular, the content of phosphorus and/or boron impurities after the thermal pre-purification may be 1 ppm or less, preferably 0.3 ppm or less.

In one embodiment of the present invention, the starting material is heated, in step a), to temperatures at which silicon dioxide remains essentially solid, but the impurities melt or form melt agglomerates.

Temperatures which are suitable therefor range from 1000° C. to 2200° C., preferably from 1300° C. to 1700° C.

In this variant, a pre-purified silicon dioxide is thus obtained in solid form.

An alternative and preferred embodiment is characterized in that, in step a), the starting material is heated to temperatures at which silicon dioxide is liquid or forms melt agglomerates, but impurities evaporate.

It has been shown, that the separation factor of volatile impurities is better with this version compared to the above named version.

Suitable temperatures at which silicon dioxide is liquid and impurities evaporate are higher than 1800° C. In this context, it should also be noted that, in this alternative embodiment, it must be made sure that the silicon dioxide is heated to this temperature as completely as possible and not only superficially.

Suitable temperatures at which silicon dioxide forms melt agglomerates start at 1500° C.

A preferred embodiment of the invention is characterized in that the starting material is directed in a gas stream at a deflector surface on which silicon dioxide and the impurities are separated from each other.

An appropriate method is known per se, for example, from EP 1 006 087 B1, whereby there the starting material is heated to temperatures at which silicon dioxide remains essentially solid, but the impurities melt or form melt agglomerates.

In this process, the deflector surface is preferably adjusted to the temperature which is suitable for the separation of impurities either in liquid form or by evaporation.

Preferably, the deflector surface is adjusted to a temperature at which silicon dioxide accumulates as a liquid and the impurities evaporate, that is, in the range of 1500° C. to 2400° C.

In a further embodiment the present invention is characterized in that step a) is conducted in the manner of a Verneuil process, wherein the starting material in step a) is heated to temperatures at which silicon dioxide is liquid or forms melt agglomerates, but the impurities evaporate.

The Verneuil process may be conducted according to the state of art or respectively with amendments known to the person skilled in the art.

In case, e.g., the required pre-purification factors is not reached, the person skilled in the art can make respective amendments. For example, the crystal may be pulled out from the device slower, the temperature may be increased or the blow-in amount of SiO₂ raw material may be adjusted.

In step a), the starting material is preferably heated to the necessary temperatures by means of a plasma flame or a high-temperature flame.

The following processes take place in an exemplary fashion when a particle of the starting material enters into the plasma flame, in particular at a high energy density:
melting of the surface of the particle;
melting of the rest of the particle and evaporation of the surface;
disintegration of the particle into individual conglomerates;
disintegration of the conglomerates into individual molecules and, subsequently, into atoms, e.g.:

SiO₂->Si+2O
recombination to form molecules as soon as the temperature begins to drop, e.g.:

Si+2O->SiO₂
solid/liquid molecules form conglomerates;
at a certain size of the conglomerates, the conglomerates will condense.

“In an exemplary fashion” means in this context that a particle entering into the plasma flame can, but does not necessarily have to, pass through the processes.

Preferably, the residence time of the molecules in the plasma flame is so long that even complex silicate compounds such as, e.g., NaAlSi₃O₈ and CaAl₂Si₂O will disintegrate, permitting the evaporation of volatile elements.

Generally speaking, any heat source which is able to produce the respective required temperature is suitable for step a).

An embodiment of the present invention is characterized in that, in step b), a single-stage reduction of silicon dioxide to elementary silicon is performed.

In doing so, the single-stage reduction can be carried out by means of a reducing agent such as carbon or carbon compounds, solid reducing agents containing carbon, or reducing gases containing hydrocarbons, as it is known per se from the prior art.

The single-stage reduction can be conducted in an induction furnace, as well as in an electric arc furnace.

An alternative embodiment of the present invention is characterized in that step b) comprises
a step b1) in which silicon dioxide is reduced to silicon monoxide, and
a step b2), following after step b1), in which silicon monoxide is further reduced to elementary silicon.

In doing so, in step b1), a reduction of the silicon dioxide to silicon monoxide by means of a gaseous reducing agent preferably takes place at a temperature of 1000° C. to 2500° C.,

whereby a gas phase containing the silicon monoxide is formed and,
in step b2), a reduction of the silicon monoxide obtained in step b1) by means of a gaseous reducing agent takes place at a temperature of 1500° C. or more, whereby elementary silicon, which is separated, and a remaining gas phase are formed.

The temperature in this step b1) is chosen to be 1000° C. or more, in particular 1000° C. up to 2500° C., such that numerous impurities of silicon dioxide such as, e.g., Ca, Cr, Mg, B, Al, Cu, Fe and Ni, remain in the solid or, respectively, liquid phase in elementary form or optionally in the form of compounds such as oxides, while the silicon monoxide that has formed enters into the gas phase.

In the second step b2), the silicon monoxide that has formed is reduced in the gas phase to elementary silicon again with a gaseous reducing agent. With temperatures of 1500° C. or more, this step is performed at a temperature at which the elementary silicon, which is forming, passes from the gas phase into the liquid or, respectively, solid phase and is thus separated. Further impurities exist in the remaining gas phase (provided that they are still present after step a)), which, in step b1), also enter into the gas phase, but remain in the gas phase at the temperature of step b2), for example, P, Na, Pb, K, Sb, Zn and As.

Both in step b1) and in step b2), reducing agents of any kind, in particular hydrogen and carbon-containing reducing agents, may generally be used as gaseous reducing agents.

In step b1), a gas from the group consisting of hydrogen and hydrocarbons gaseous at room temperature, in particular methane, ethane, propane, butane, hexane and heptane or mixtures thereof, is preferably used as a gaseous reducing agent. Particularly preferably, the reducing agent in step b1) comprises hydrogen or is hydrogen.

In step b2), a gas from the group consisting of hydrogen, hydrocarbons gaseous at room temperature, in particular methane, ethane, propane, butane, hexane and heptane, or mixtures thereof, is preferably used as a gaseous reducing agent. Particularly preferably, the reducing agent in step b2) comprises methane or is methane.

The temperature in step b1) amounts to 1000° C. or more, in particular 1000° C. to 2500° C., preferably 1200° C. or more, in particular 1200° C. to 2500° C., preferably 1600° C. to 2500° C., particularly preferably 1900° C. to 2050° C.

The temperature in step b2) amounts to 1500° C. or more, preferably 1700° C. to 2600° C., preferably 1900° C. to 2600° C., particularly preferably 1900° C. to 2200° C., particularly preferably 1950° C. to 2200° C. or 1950° C. to 2100° C.

Such a procedure is described in WO 2018/141805 A1. For further details of this procedure, reference is made to the disclosure of this patent application.

With a two-stage reduction of the silicon dioxide, this embodiment preferably comprises the further

step b3) of cooling the gas phase remaining in step b2) to a temperature of 500° C. or less and recovering the gaseous reducing agent.

Advantageously, on the one hand, the impurities still remaining in the gas phase are thereby separated, and the gaseous reducing agent or, respectively, the gaseous reducing agents is/are recovered.

In general, for both step a) as well as for step b), all used materials (gas, refractory burner etc.) should of course not bring in additional, undesired impurities.

In the respective aggregate used, a certain overpressure may be adjusted to achieve a shiedling to the atmosphere and to prevent the penetration of impurities from outside.

In the variant of the two-stage reduction of the silicon dioxide, a removal of impurities having a higher boiling point than SiO preferably occurs during step b1).

At the temperatures ranging from 1000° C. to 2500° C., which are preferably used in step b1), the silicon monoxide, which is forming, enters into the gas phase, with less volatile impurities remaining. Thus, step c) of the method according to the invention, namely the removal of impurities remaining in the pre-purified silicon dioxide after step a), takes place during step b1).

In a further embodiment of the method according to the invention, step c) comprises the removal of impurities contained in the obtained elementary silicon by means of zone melting.

In this embodiment, step c) is thus carried out after step b). The purification step by means of zone melting can be carried out in particular after a single-stage reduction of the silicon dioxide. However, zone melting may also take place after a two-stage reduction according to steps b1) and b2), whereby an additional purification of the obtained elementary silicon is achieved.

The purification of elementary silicon by means of zone melting is known. As an alternative to zone melting, any form of unidirectional solidification is possible, exploiting the varying solubilities of impurities in solid and liquid silicon.

The starting material for the method according to the invention is impure silicon dioxide, in particular impure natural silicon dioxide.

The proportion of silicon dioxides in the starting material may be at least 85%, preferably at least 95%, particularly preferably 98% and more.

A particularly preferred starting material is quartz sand.

The starting material is advantageously present in the form of a powder or as a granulated material with particle sizes of 0.0002 mm to 3 mm, in particular 0.05 mm to 0.2 mm.

The starting material may include further silicon-oxygen compounds, in particular inorganic silicon-oxygen compounds of the formula SiₓO_{y}, wherein x≥1 and y>1, or organic silicon-oxygen compounds, e.g. siloxanes or silicones. These can be co-processed in particular in a variant in which a separation of impurities is performed in step a) by means of a plasma flame.

A further preferred embodiment of the present invention is characterized in that the starting material used in step a) contains a viscosity-reducing substance.

Thereby, the processing of the starting material in step a) can be simplified.

Preferably, a viscosity-reducing substance is used which has a separation factor of less than 0.005.

For the purposes of the present invention, the “separation factor” is understood to be the “solubility” of the substance concerned in solid silicon, divided by the solubility in liquid silicon.

Particularly preferably, the viscosity-reducing substance is iron oxide.

A further embodiment of the method according to the invention comprises the additional step of a magnetic separation of impurities having magnetic properties.

The magnetic separation step can be performed before step a) and/or before step b).

As already mentioned, steps a), b) and/or c) can preferably be performed essentially without the use of halogen-containing compounds. Particularly preferably, steps a), b) and c) are all carried out essentially without the use of halogen-containing compounds.

### Examples and, Respectively, Explanations of the Figures

FIG. 1 schematically shows the separation of impurities from a starting material containing silicon dioxide in a first preferred embodiment of the method according to the invention.

In the following, the starting material will be referred to as impure silicon dioxide 2.

Specifically, FIG. 1 shows an embodiment of step a), namely the thermal pre-purification of the impure silicon dioxide 2. The device 1 preferably used for this purpose comprises a burner 3 for generating a high-temperature flame 4 and a deflector plate 5. To produce the high-temperature flame 4, the burner 3 is advantageously supplied with hydrogen or acetylene. In addition, oxygen may also be supplied to the burner 3. The deflector plate 5 is arranged at a distance from the high-temperature flame 4 in an exhaust gas stream 6 of the high-temperature flame 4.

The impure silicon dioxide 2 is advantageously present in the form of a powder with a grain size of between 0.0002 mm and 3 mm, in particular from 0.05 mm to 0.2 mm.

Via an inlet, which is not illustrated, the impure silicon dioxide 2 is fed directly into the high-temperature flame 4. In doing so, the flame temperature of the high-temperature flame 4 and an amount of impure silicon dioxide 2 supplied to the high-temperature flame 4 are chosen such that the impure silicon dioxide 2 is heated to a temperature at which the silicon dioxide remains essentially solid, but impurities melt or form melt agglomerates 7. Essentially solid in this context means that the silicon dioxide is not melted at all or only superficially. Advantageously, the temperature to which the impure silicon dioxide 2 is heated amounts to approximately 1300° C.-1500° C. The melt agglomerate 7 is hurled by the exhaust gas stream 6 against the deflector plate 5, where it sticks. Silicon dioxide 8, which remains solid at those temperatures, is discharged from the exhaust gas stream 6 as a result of gravity and is collected on a collecting element 9, for example, a container, a chute or a conveyor belt.

Advantageously, the deflector plate 5 is automatically cleaned from the melt agglomerate 7 in a recurring fashion.

The silicon dioxide 8 pre-purified by the device 1 in this manner is reduced to elementary silicon in a subsequent step b). Advantageously, the reduction takes place in a single-stage process using carbon. The reduction may take place, for example, in an electric arc furnace, wherein the pre-purified silicon dioxide 8 is advantageously ground, mixed with the reducing agent and pressed for this purpose.

The elementary silicon obtained in the above-indicated step b) is separated in a further step c) from the remaining impurities present in the elementary silicon by at least partial melting.

This occurs, for example, by zone melting, whereby the impurities can be separated easily after the zone melting.

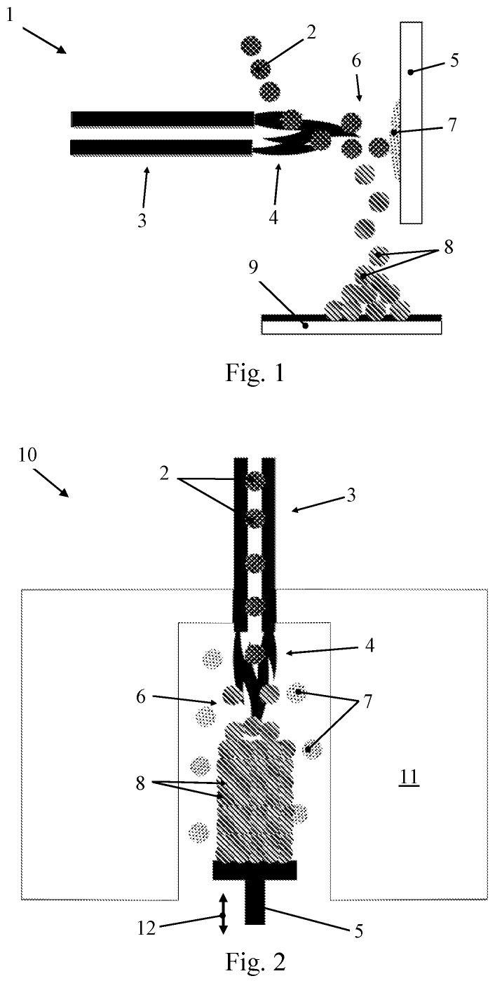

FIG. 2 schematically shows the separation of impurities from a starting material containing silicon dioxide in a second preferred embodiment of the method according to the invention.

Specifically, FIG. 2 shows an embodiment of step a). The device 10 preferably used for this purpose comprises a burner 3 for generating a high-temperature flame 4, a housing 11 and a deflector plate 5. To produce the high-temperature flame 4, the burner 3 is advantageously supplied with hydrogen or acetylene. In addition, oxygen may also be supplied to the burner 3. The deflector plate 5 can be driven linearly along the arrow 12 by means of a drive unit, which is not illustrated, and is arranged in an exhaust gas stream 6 of the high-temperature flame 4.

The impure silicon dioxide 2 is advantageously present in the form of a powder with a grain size of between 0.0002 mm and 3 mm, in particular from 0.05 mm to 0.2 mm.

The impure silicon dioxide 2 is fed via the burner 3 directly into the high-temperature flame 4. In doing so, the flame temperature of the high-temperature flame 4 and an amount of impure silicon dioxide 2 supplied to the high-temperature flame 4 are chosen such that the impure silicon dioxide 2 is heated by the high-temperature flame 4 to a temperature at which the silicon dioxide becomes liquid and impurities 7 having a boiling point lower than that of silicon dioxide will evaporate. Advantageously, the temperature to which the impure silicon dioxide 2 is heated amounts to more than 1800° C., in particular 2100° C. The liquefied silicon dioxide 8 is hurled by the exhaust gas stream 6 against the deflector plate 5, where it settles and solidifies. By a linear drive 12 of the deflector plate 5, the deflector plate 5 can be moved away from the high-temperature flame 4 to prevent the pre-purified silicon dioxide 8, which settles on the deflector plate 5, from “growing” in the direction of the high-temperature flame 4. The evaporated impurities 7 are discharged. From time to time, the pre-purified silicon dioxide 8 is removed from the deflector plate 5.

Advantageously, the silicon dioxide 8 pre-purified in this manner is ground in a subsequent step b) and is reduced to elementary silicon in a two-stage process, as described in WO 2018/141805. In the first stage of said process, the pre-purified silicon dioxide 8 is reduced to silicon monoxide by means of a gaseous reducing agent at a temperature of 1000° C. to 2500° C. In the second stage of this process, the silicon monoxide is reduced to elementary silicon by means of another gaseous reducing agent at a temperature of 1500° C. or more.

Subsequently, the elementary silicon thus obtained is separated from the remaining impurities by zone melting, again like in the embodiment of the method according to the invention as described according to FIG. 1, in order to obtain elementary silicon.

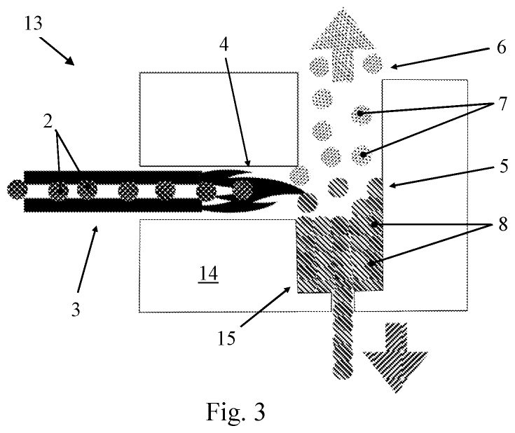

FIG. 3 schematically shows the separation of impurities from a starting material containing silicon dioxide in a third preferred embodiment of the method according to the invention.

Specifically, FIG. 3 shows an embodiment of step a). A device 13 preferably used for this purpose comprises a burner 3 for generating a high-temperature flame 4, a housing 14 and a deflector plate 5. To produce the high-temperature flame 4, the burner 3 is advantageously supplied with hydrogen or acetylene. In addition, oxygen may also be supplied to the burner 3. The deflector plate 5 is part of the housing 14.

The impure silicon dioxide 2 is advantageously present in the form of a powder with a grain size of between 0.0002 mm and 3 mm, in particular from 0.05 mm to 0.2 mm.

The impure silicon dioxide 2 is fed via the burner 3 directly into the high-temperature flame 4. In doing so, the flame temperature of the high-temperature flame 4 and an amount of impure silicon dioxide 2 supplied to the high-temperature flame 4 are chosen such that the impure silicon dioxide 2 is heated by the high-temperature flame 4 to a temperature at which the silicon dioxide becomes liquid and impurities 7 having a boiling point lower than that of silicon dioxide will evaporate. Advantageously, the temperature to which the impure silicon dioxide 2 is heated amounts to more than 1800° C., in particular 2100° C. The liquefied silicon dioxide 8 is hurled by the exhaust gas stream 6 against the deflector plate 5. The housing 14 of the device 13 is tempered such that the pre-purified silicon dioxide 8 remains liquid and sinks into a container 15 of the housing 14, from where it can be withdrawn as a strand. The evaporated impurities 7 are discharged. Advantageously, the housing is tempered to more than 1800° C., in particular to 2100° C.

The further processing of the pre-purified silicon dioxide to elementary silicon occurs according to the explanations for FIG. 1 or FIG. 2.

In a further embodiment, it is possible that the burner 3 of the devices 1, 10 or 13 is formed by a plasma torch for generating a plasma flame.

In a particularly preferred embodiment of the method according to the invention:

in step a), the starting material is first pre-purified using any of the devices 1, 10 or 13, subsequently, the pre-purified silicon dioxide is ground and mixed with a (boron-free) reducing agent and pressed,
in step b), the pre-purified silicon dioxide, which has been mixed with the reducing agent and pressed, is reduced in an electric arc furnace to elementary silicon in the form of granules or in the form of a strand; and
in step c), remaining impurities are deposited by subsequent zone melting in order to obtain elementary silicon dioxide.

The present application further discloses a method for the production of elementary silicon from a starting material (2) containing silicon dioxide, comprising the steps:
a) thermal pre-purification of the starting material (2), wherein impurities (7) with a boiling point that is lower than that of silicon dioxide are separated and a pre-purified silicon dioxide (8) is obtained
b) reduction of the pre-purified silicon dioxide (8) to elementary silicon
c) removal of impurities (7) remaining in the pre-purified silicon dioxide (8) after step a) during and/or after step b).

For further details of steps a), b) and c) the above disclosure applies analogously.

1. A method for the production of high-purity elementary silicon from a starting material containing silicon dioxide, comprising the steps of:
a) thermal pre-purification of the starting material, wherein impurities from the group consisting of boron and phosphorus are separated essentially completely and a pre-purified silicon dioxide is obtained;
b) reduction of the pre-purified silicon dioxide to elementary silicon; and
c) removal of impurities remaining in the pre-purified silicon dioxide after step a) during and/or after step b).

2. A method according to claim 1, wherein further impurities with a boiling point that is lower than that of silicon dioxide are separated essentially completely in step a).

3. A method according to claim 1, wherein, in step a), the starting material is heated to temperatures at which silicon dioxide remains essentially solid, but the impurities melt or form melt agglomerates.

4. A method according to claim 1, wherein, in step a), the starting material is heated to temperatures at which silicon dioxide is liquid or forms melt agglomerates, but the impurities evaporate.

5. A method according to claim 3, wherein the starting material is directed in a gas stream at a deflector surface on which silicon dioxide and the impurities are separated from each other.

6. A method according to claim 4, wherein step a) is conducted in the manner of a Verneuil process.

7. A method according to claim 3, wherein the starting material is heated to the necessary temperatures by means of a plasma flame or a high-temperature flame.

8. A method according to claim 1, wherein in step b), a single-stage reduction of silicon dioxide to elementary silicon is performed.

9. A method according to claim 1, wherein step b) comprises:
a step b1) in which silicon dioxide is reduced to silicon monoxide, and
a step b2), following step b1), in which silicon monoxide is further reduced to elementary silicon.

10. A method according to claim 9, wherein
in step b1), a reduction of the silicon dioxide to silicon monoxide by means of a gaseous reducing agent takes place at a temperature of 1000° C. to 2500° C., whereby a gas phase containing the silicon monoxide is formed and,
in step b2), a reduction of the silicon monoxide obtained in step b1) by means of a gaseous reducing agent takes place at a temperature of 1500° C. or more, whereby elementary silicon, which is separated, and a remaining gas phase are formed.

11. A method according to claim 10, comprising the further step b3) of cooling the gas phase remaining in step b2) to a temperature of 500° C. or less and recovering the gaseous reducing agent.

12. A method according to claim 10, wherein step c) comprises the removal of impurities having a higher boiling point than silicon monoxide during step b1).

13. A method according to any of the preceding claims, characterized in that step c) comprises the removal of impurities contained in the obtained elementary silicon by means of zone melting.

14. A method according to claim 1, wherein the proportion of silicon dioxide in the starting material (2) is at least 85%.

15. A method according to claim 1, wherein the starting material used in step a) contains a viscosity-reducing substance.

16. A method according to claim 15, wherein the viscosity-reducing substance has a separation factor of less than 0.005.

17. A method according to claim 16, wherein the viscosity-reducing substance is iron oxide.

18. A method according to claim 1, wherein it the method is carried out essentially without the use of halogen-containing compounds.

19. A method according to claim 14, wherein the proportion of silicon dioxide in the starting material is at least 95%.

20. A method according to claim 14, wherein the proportion of silicon dioxide in the starting material is 98% or more.
